(19) United States
(12) Patent Application Publication
(10) Pub. No.: US 2001/0053132 A1
(43) Pub. Date: Dec. 20, 2001

(54) Management method and a conference unit for use in a communication system including user terminals communicating by means of the internet protocol

(76) Inventors: Lue Attimont, Saint Germain En Laye (FR); Pierre Bonnard, Suresnes (FR)

Correspondence Address: SUGHRUE, MION, ZINN, MACPEAK & SEAS, PLLC, 2100 Pennsylvania Avenue, N.W., Suite 800, Washington, DC, 20037-3213, US

(21) Appl. No.: 09/848,403

(22) Filed: May 4, 2001

(30) Foreign Application Priority Data
Jun. 19, 2000 (FR) 00 07 789

(51) Int. Cl. H04L 12/16

(52) U.S. Cl. 370/260; 455/416

(57) ABSTRACT

A method is disclosed of managing a voice mode conference call between users of terminals which are organized so that they can communicate with each other in packet mode by means of the Internet protocol or an equivalent protocol in the context of a communication system and in particular via an arrangement which enables them to be connected in a conference call and then to receive a signal from each of the terminals participating in the conference call and to broadcast the signal from a temporarily chosen terminal to the other terminals. Regular and transparent detection of voice activity in the compressed signals from the conference call terminals determines the received signal whose energy level is the highest of the energy levels considered at a given time, as defined by voice coding parameters for each signal included in the packets by means of which they are transmitted.

### BACKGROUND OF THE INVENTION

1. Field of the Invention

The invention relates to a management method and a conference unit for use in a communication system which includes user terminals able to communicate with each other by means of the Internet protocol or an equivalent protocol to enable a plurality of terminals to participate in a conference call.

2. Description of the Prior Art

Conference calls between users of voice terminals connected to a communication network are conventionally effected by means of a conference unit (bridge) which in some cases is included in one of the terminals involved in a conference call. The arrangement is sometimes included in a unit constituting a communication network node, for example a PABX, in the form of one or more conference call units (bridges).

A conference unit conventionally receives speech signals from all user terminals participating in a conference call and connected to it and, at least in theory, is able to retransmit to each of the terminals either a signal resulting from combinatorial processing of the signals received from the participating terminals or a signal from one of the participating terminals that is temporarily selected at the time. A participating terminal naturally does not need to receive the signal it sends. It is not always possible to mix the speech signals from all the participants in a conference call, in particular if the number of participants is large, and it is often preferable for the signal transmitted to come from only one terminal at a time. This can be achieved by strict compliance of participants with rules governing who can speak if the conference unit combines the signals received from each of the terminals involved in a conference call into a signal to be broadcast to the other participants. Another solution, often referred to by the term “push-pull”, employs means for selecting for retransmission the signal received from one of the participating terminals whose user is speaking at the time, in particular so-called voice activity detector means.

When a conference unit serves terminals connected to a general switched telephone network it performs a large number of signal processing operations simultaneously for synchronizing, decoding, mixing and re-encoding the signals that it receives from the conference call terminals. This implies the use of complex and particularly fast hardware, in particular if a good quality speech signal, based on signals from the terminals, which may differ in terms of quality, is to be retransmitted from the conference unit to the participating terminals. The complexity and cost of the hardware tend to increase sharply if the participating terminals communicate with each other in packet mode and by means of the Internet protocol. In this case the speech signals produced by the terminals are compressed by complex algorithms. The conference unit decodes all the signals that it receives simultaneously from the conference call terminals so that it can mix them, and the signal or signals resulting from such mixing are re-encoded before they are broadcast.

The conference unit of this kind of solution, which is also referred to as a multipoint control unit (MCU), is covered by the H.323 standard in particular. It entails a very high signal processing power, in excess of several hundred MIPS, and consequently a high cost in terms of processing hardware.

### SUMMARY OF THE INVENTION

The invention therefore proposes a method of managing a voice mode conference call between users of terminals which are organized so that they can communicate with each other in packet mode by means of the Internet protocol or an equivalent protocol in the context of a communication system and in particular via an arrangement adapted to enable them to be connected in a conference call and then to receive a signal from each of the terminals participating in the conference call and to broadcast the signal from a temporarily chosen terminal to the other terminals, in which method regular and transparent detection of voice activity in the compressed signals from the conference call terminals determines the received signal whose energy level is the highest of the energy levels considered at a given time, as defined by voice coding parameters for each signal included in the packets by means of which they are transmitted.

According to the invention, voice activity is detected in a useful real time protocol part of respective packets received from the conference call terminals and time stamps individually assigned to the packets enable the packets which have time stamps that are identical, or nearby and quasi-identical, given the scale of the detection function for determining the signal having the highest energy level from the received signals considered to have identical time stamps at the same given time, to be determined.

According to the invention, a voice activity detection function includes a threshold hysteresis for temporarily favoring a terminal whose signal was broadcast until then because it had the highest energy level if the signal from another conference call terminal reaches an energy level higher than that of the signal broadcast until then.

The invention also provides a conference unit enabling simultaneous communication between a plurality of user terminals of a communication system by means of the Internet protocol or an equivalent protocol in the context of a one-at-a-time conference call in which only one of the respective signals sent in the form of packets by the conference call terminals is selected at a given time to be broadcast to the other terminals participating in the conference call, which arrangement includes voice activity detector means for determining the energy level of the speech signal sent by a user terminal from voice coding parameters included in successive packets by means of which the signal is transmitted, and means enabling it to determine from among the transmitted signals considered at a given time the transmitted signal whose energy level is the highest.

Means are provided enabling the conference unit to fix a threshold hysteresis for temporarily favoring a terminal whose signal was broadcast until then because it had the highest energy level if a signal from another conference call terminal reaches an energy level higher than that of the signal broadcast until then.

According to the invention, the conference unit is incorporated into a user telecommunication terminal, or a unit of a telecommunication network node, or a unit connected to a shared telecommunication link and in particular to a unit of a link forming a loop local area network.

The invention, its features and its advantages are explained in the following description, which refers to the single figure of the accompanying drawing.

### BRIEF DESCRIPTION OF THE DRAWING

The single FIGURE of the accompanying drawing is a simplified block diagram relating to a communication system including a voice conference unit in accordance with the invention linking user terminals.

### DETAILED DESCRIPTION OF THE PREFERRED EMBODIMENT

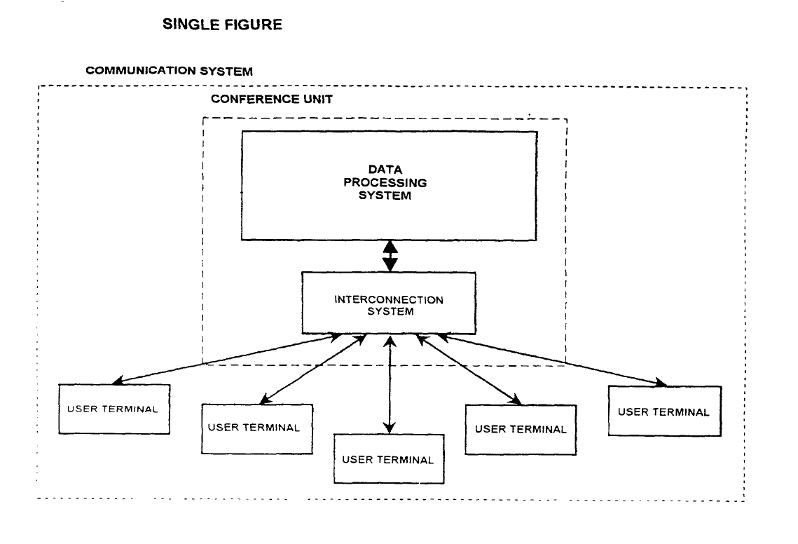

In the communication system shown in part and diagrammatically in FIG. 1 user terminals 1 are able to communicate with each other via a communication network to which the terminals 1 are connected and which includes a conference unit 2 by means of which the terminals can be selectively connected into a voice mode conference call. As is known in the art, the arrangement 2 can be included in a switching unit, for example a telephone central office, to which the terminals are connected either directly or via other switching units of a meshed communication network such as the standard telephone network. The arrangement 2 can instead be a dedicated unit of a ring network comprising either a single ring or a number of interleaved rings and to which the terminals 1 are connected. It can instead be incorporated in a user terminal equipped to set up a conference call between other terminals via a more or less sophisticated network of communication links.

Whichever of the above options applies, the arrangement 2 incorporates or is associated with an interconnection system 3 which can temporarily store speech signals emanating from terminals participating in a conference call before the signals are processed and re-routed to the participating terminals, which then constitute their destination. The arrangement 2 further includes a data processing system 4 which preferably has management and processing functions and which in this example controls the conference call phase. The data processing system 4 is constructed around one or more appropriately programmed processors. In this non-limiting example it is included in the conference unit 2 along with an interconnection system 3 enabling a particular maximum number “n” of user terminals 1 to participate simultaneously in the same conference call.

The management method according to the invention is implemented in a communication system whose constituents that can be involved in a conference call, such as the terminals 1 and the arrangement 2, are adapted to enable users to set up voice over Internet protocol (VOIP) telephone calls set up using the Internet protocol or an equivalent protocol via a network enabling transmission of packets, in particular the Internet.

The management method according to the invention concerns the most common kind of conference call, set up between a limited number of participants, for example of the order of three to ten participants. It is therefore possible not to have to mix speech signals coming simultaneously from several participants using a conference bridge employing the push-pull solution referred to above in which the signal broadcast to the terminals of users participating in a conference call is a signal coming from only one terminal at a time. To this end, when terminals are participating in a conference call, quasi-permanent voice activity detection is effected by a function implanted in the data processing system 4 to determine the terminal whose signal will be broadcast to the others.

According to the invention, voice activity detection is applied transparently to compressed speech signals received in the form of packets from the participating terminals, i.e. without decompressing signals each coming from a different terminal, because the signal broadcast comes from only one terminal at a time and therefore no mixing is required.

In the embodiment shown in FIG. 1, the conference unit is a VOIP unit which includes an interconnection system 3 whose “n” ports P₁ to Pₙ enable interconnection of “n” terminals 1 when setting up a conference call and for the duration of that conference call. Exchanges between a terminal and the port to which it is connected are effected under the standard real time protocol (RTP), for example. The speech signals that a terminal produces from voice mode signals that it receives from a user are compressed and formed into packets in the terminal, for example using one or other of the standard G.723.1 or G.729 voice compression algorithms, before they are transmitted by that terminal to the port to which it is connected.

The transparent voice activity detection function of the processing system sorts the useful parts of the RTP messages that constitute the packets of signals that it receives from the conference call terminals and assigns them time stamps that are temporarily stored in a synchronization table. The packets from the various conference call terminals whose time stamps are identical, or close together and quasi-identical, given the scale of the function, are analyzed in real time to determine their respective energies. This is effected by exploiting the voice coding parameters, such as the excitation energy and the gain in height or “pitch”, which are accessible in the encoded packets, without having to decode the voice signals.

The processing system compares the respective energies of the speech signal sources consisting of the terminals whose packets have identical or quasi-identical time stamps to determine which is producing the highest energy signal at the time and will therefore be temporarily broadcast to the other conference call terminals. As indicated above, it is not necessary to decompress the packets emanating from the selected terminal to enable broadcasting.

The comparison can be based on the respective absolute values of the energies of the signals to be compared. To allow for any disparities between sources, another solution may be preferred, and in particular one which takes into account the absolute value of the signal emanating from a source, associated with a correction factor calculated for that source. That factor is based on the difference between the current value of the energy at a given time and an average value calculated over a particular time interval preceding that given time, for example.

It is, of course, essential to prevent speech signals from a conference call user who is speaking from being suddenly replaced by those from another user and temporarily of higher energy. To this end, the transparent voice activity detection function has a threshold hysteresis to enable transmission of packets relating to a signal from a terminal to continue if a temporarily more powerful signal from another terminal appears. In a manner that is well-known to the skilled person, the hysteresis provided in the context of speech signal detection is also used to prevent a period of silence while a user is speaking causing a drop in the energy level of the signal transmitted by that user's terminal leading to the broadcasting of a signal from a different terminal instead of the signal broadcast until then. The audible effect of such hysteresis can be reduced to a level that is practically imperceptible for the conference call users when the broadcast signal changes from a signal from one terminal to a signal from another terminal, given the possibilities of variation conferred by the technique of transferring signals in packets.

The conference management method according to the invention avoids the need for decompression of speech signals from conference call terminals in the conference unit from which the signal emanating from one of the terminals is broadcast and recompression of the signal to be broadcast, as conventionally applied in the conference unit. The content of the packets from the terminal whose signal is temporarily to be broadcast in the context of a conference call is simply reproduced for retransmission to the other conference call terminals, without it being necessary to modify it. This economizes a good deal of the calculating power required of the signal processor(s) of the processing system 4 of the conference unit. Thus if a conference unit for simultaneous communication by four terminals in VOIP mode necessitates decoding of signals transmitted by three of the terminals and re-encoding of the signal transmitted by the fourth, in accordance with the prior art technique, and entails a calculation power of the order of 20.5 MIPS ((3×3.5)+10), the management method according to the invention in practice reduces by one the number of signal processors in a conference unit.

Furthermore, the transparent voice activity detection function is also less costly in terms of calculation power than conventional voice activity detection applied to the signals from the terminals if those signals are decoded in the conference unit.

Finally, the conference call management method according to the invention eliminates the degradation of the signal from one of the terminals broadcast by the conference unit that occurs if the arrangement decodes and then re-encodes that signal. The signal broadcast when the conference management method according to the invention is used retains the quality that it had when it left the terminal from which it comes. It is therefore possible to provide conference units such that the sound signals broadcast retain a quality equal to that which they had on leaving the terminal which initially transmitted them, and this is achieved at a lower cost than by prior art conference units of the same category.

As already indicated, the conference call management method according to the invention can be used in conference units that are functionally structured in a corresponding manner and implemented in different hardware forms. A conference unit enabling use of the management method in accordance with the invention can therefore be part of a dedicated user terminal to which other user terminals are connected temporarily and either directly or via a communication network, as known in the art. A different embodiment of the conference unit can constitute a dedicated unit of a network or one unit of a node of a more or less sophisticated communication network.

There is claimed:

1. A method of managing a voice mode conference call between users of terminals which are organized so that they can communicate with each other in packet mode by means of the Internet protocol or an equivalent protocol in the context of a communication system and in particular via an arrangement adapted to enable them to be connected in a conference call and then to receive a signal from each of the terminals participating in the conference call and to broadcast the signal from a temporarily chosen terminal to the other terminals, in which method regular and transparent detection of voice activity in the compressed signals from the conference call terminals determines the received signal whose energy level is the highest of the energy levels considered at a given time, as defined by voice coding parameters for each signal included in the packets by means of which they are transmitted.

2. The method claimed in claim 1 wherein voice activity is detected in a useful real time protocol part of respective packets received from said conference call terminals and time stamps individually assigned to said packets enable said packets which have time stamps that are identical, or nearby and quasi-identical, given the scale of the detection function for determining the signal having the highest energy level from the received signals considered to have identical time stamps at the same given time, to be determined.

3. The method claimed in claim 1 employing a voice activity detection function including a threshold hysteresis for temporarily favoring a terminal whose signal was broadcast until then because it had the highest energy level if the signal from another conference call terminal reaches an energy level higher than that of said signal broadcast until then.

4. A conference unit enabling simultaneous communication between a plurality of user terminals of a communication system by means of the Internet protocol or an equivalent protocol in the context of a one-at-a-time conference call in which only one of the respective signals sent in the form of packets by the conference call terminals is selected at a given time to be broadcast to the other terminals participating in the conference call, which arrangement includes:
voice activity detector means for determining the energy level of the speech signal sent by a user terminal from voice coding parameters included in successive packets by means of which said signal is transmitted, and
means enabling it to determine from among the transmitted signals considered at a given time the transmitted signal whose energy level is the highest.

5. The conference unit claimed in claim 4 including means enabling it to fix a threshold hysteresis for temporarily favoring a terminal whose signal was broadcast until then because it had the highest energy level if a signal from another conference call terminal reaches an energy level higher than that of said signal broadcast until then.

6. The conference unit claimed in claim 4 incorporated into a user telecommunication terminal.

7. The conference unit claimed in claim 4 incorporated in a unit of a telecommunication network node.

8. The conference unit claimed in claim 4 incorporated in a unit connected to a shared telecommunication link and in particular to a unit of a link forming a loop local area network.
